(19) United States
(12) Patent Application Publication
(10) Pub. No.: US 2018/0342169 A1
(43) Pub. Date: Nov. 29, 2018

(54) AUTONOMOUS DRONE SERVICE SYSTEM

(71) Applicant: International Business Machines Corporation, Armonk, NY (US)

(72) Inventors: Michael S. Gordon, Yorktown Heights, NY (US); James R. Kozloski, New Fairfield, CT (US); Peter K. Malkin, Ardsley, NY (US); Clifford A. Pickover, Yorktown Heights, NY (US)

(21) Appl. No.: 16/036,103

(22) Filed: Jul. 16, 2018

Related U.S. Application Data
(62) Division of application No. 14/687,306, filed on Apr. 15, 2015.

(51) Int. Cl. G08G 5/00; G06Q 30/06; G08G 1/00; B64C 39/02; G05D 1/10; G06Q 10/06

(52) U.S. Cl. CPC G08G 5/0069; G06Q 30/0635; G08G 5/006; G08G 5/0056; G08G 5/0043; G08G 1/202; B64C 2201/027; G05D 1/101; G06Q 10/06312; B64C 2201/127; B64C 2201/128; B64C 2201/126; B64C 39/024

(57) ABSTRACT

An autonomous drone service system controls at least one drone vehicle configured to autonomously navigate along a flight path to provide one or more services requested by a user. The system includes an electronic service provider device to receive at least one service request signal generated by a user device. The request signal indicates at least one requested service provided by the drone service system and location or locations associated with the requested services. The electronic service provider device that automatically maps the at least one requested service to the at least one drone vehicle, and commands the at least one drone vehicle to perform the service request at the one or more locations.

### DOMESTIC PRIORITY

This application is a divisional of U.S. patent application Ser. No. 14/687,306, filed Apr. 15, 2015, the disclosure of which is incorporated by reference herein in its entirety.

### BACKGROUND

The present invention relates to autonomous drones, and more specifically, to a system configured to control drones to provide various services to a user.

Autonomous drones, also referred to as unmanned aerial vehicles (UAVs) and remotely piloted aircraft (RPA) are expected to be ruled eligible for private domestic use subject to pending to regulations implemented by various aviation authorities such as, for example, the Federal Aviation Admiration (FAA). Proposed domestic uses for drones include, but are not limited to, city ordinance enforcement, other government functions, package delivery, and image capturing. Therefore, it is envisioned that users could purchase drones to achieve a certain set of private needs or tasks. However, some users may need the drone to perform only a limited number of tasks such that the costs and complexity of purchasing and operating one or more drones become impractical for the user.

Conventional drone services to date include rent-a-drone services, which allow users to temporarily rent a drone to perform various tasks. However, users themselves are typically required to fully control and operate the drones. Many rent-a-drone services also require users to complete a drone training class to ensure users learn how to properly operate the drones. These training classes, however, typically require further payment, and prevent instantaneous drone-executed service. In addition, users are expected to fully comply with all regulations enforced by aviation authorities, along with other state/city zoning and property restrictions. Even after completing the training class, users are typically liable for damages of the drone incurred during flight operations. Therefore, conventional rent-a-drone services do not provide users with a convenient means for completing a limited number of drone-executed tasks.

### SUMMARY

According to at least one embodiment, an autonomous drone service system controls at least one drone vehicle configured to autonomously navigate along a flight path to provide one or more services requested by a user. The system includes an electronic service provider device to receive at least one service request signal generated by a user device. The request signal indicates at least one requested service provided by the drone service system and location or locations associated with the requested services. The electronic service provider device automatically maps the at least one requested service to the at least one drone vehicle, and commands the at least one drone vehicle to perform the service request at the one or more locations.

In addition to one or more of the features described above or below, or as an alternative, further embodiments include:

a feature, where the at least one drone vehicle includes a plurality of drone vehicles, and the electronic service provider device selects the at least one drove vehicle from among the plurality of drone vehicles in response to automatically mapping the service request to drone features included with the plurality of drone vehicles;

a feature, where the electronic service provider transmits at least one user-selectable criteria to the at least one user device in response to receiving the least one service request signal;

a feature, where the electronic service provider automatically maps at least one received user-selectable criteria with at least one drone vehicle among the plurality of drone vehicles, and automatically selects the at least one drove vehicle based on a match between the at least one received user-selectable criteria and a drone feature of the at least one drone vehicle;

a feature, where the electronic service provider device transmits flight regulation data to the selected at least one drone vehicle, and wherein the selected at least one drone vehicle performs the requested service while avoiding at least one restricted travel zone indicated by the flight regulation data; and

a feature, where the electronic service provider device modifies the service request based on a comparison between a current monetary cost to perform the service request and a cost budget input by the user.

According to another embodiment, a method uses at least one autonomous drone vehicle to perform at least one service provided by a drone service system comprises receiving from an electronic user device at least one request for a service provided by the drone service system at one or more user-indicated locations. The method includes determining at least one available drone registered with the drone service system, and automatically mapping the at least one request to at least drone feature included with the at least one available drone to determine whether the at least one available drone is able to perform the at least one request. The method further includes commanding the at least one available drone to perform the service request at the one or more locations in response to determining that the at least one available drone includes at least one drone feature able to perform the at least one request.

In addition to one or more of the features described above or below, or as an alternative, further embodiments include:

a feature of transmitting at least one user-selectable criteria to the user device based on the at least one request;

a feature of receiving at least one user-selected criteria from among the plurality of drone features, and wherein the commanding the at least one available drone further comprises determining that the at least one available drone includes at least one drone feature mapped to the received at least one user-selected criteria;

a feature of transmitting flight regulation data to the selected at least one drone vehicle, and performing the requested service via the selected at least one autonomous drone vehicle while avoiding at least one restricted travel zone indicated by the flight regulation data; and

a feature of modifying the operation of the selected at least one autonomous drone vehicle based on a comparison between a current monetary cost to perform the service request and a cost budget input by the user.

According to yet another embodiment, an electronic control system that performs at least one service using at least one autonomous drone vehicle included in a drone service system comprises an electronic drone identification (ID) database unit that stores ID information identifying at least one registered autonomous drone vehicle included in the drone service system. The control system further comprises an electronic drone selection module in signal communication with an electronic user device to receive a service request for at least one service provided by the drone service system. The drone selection module includes an electronic microprocessor having electronic memory that stores computer readable instructions that when executed by the microprocessor determines at least one currently operating drone among the at least one registered autonomous drone vehicle based on a received drone ID. The drone selection module automatically maps the at least one service request to the at least one currently operating drone vehicle to select at least one drone to perform the service request, and automatically commands the at least one selected drone to perform the service request.

In addition to one or more of the features described above or below, or as an alternative, further embodiments include:

a feature, where the electronic drone selection module transmits at least one user-selectable criteria provided by the at least one currently operating drone to the user device, and wherein the electronic drone selection module selects the at least one drone in response to receiving at least one selected user-selectable criteria returned by the user device;

a feature, where the at least one user-selectable criteria is selected from a list comprising camera type, pixel rate, video recording camera type, data streaming capability, sound recording capability, the maximum package delivery weight capability, night vision capability, weather-proofing availability, maximum speed, maximum altitude;

a feature, where an electronic zone/regulation module that stores flight regulation data indicating at least one restricted travel zone; and

a feature, where the electronic drone selection module retrieves the flight regulation data and transmits the flight regulation data to the selected at least one drone such that the at least one drone performs the service request while avoiding the at least one restricted travel zone.

According to still another embodiment, a method of performing at least one service using at least one autonomous drone vehicle included in a drone service system comprises cross-referencing at least one registered autonomous drone vehicle included in the drone service system with a respective drone identification (ID). The method further comprises receiving a service request for at least one service provided by the drone service system. The method further comprises determining at least one currently operating drone among the at least one registered autonomous drone vehicle based on a received drone ID. The method further comprises automatically mapping the at least one service request to the at least one currently operating drone vehicle to select at least one drone to perform the service request, and automatically commanding the at least one selected drone to perform the service request.

In addition to one or more of the features described above or below, or as an alternative, further embodiments include:

a feature of transmitting at least one user-selectable criteria provided by the at least one currently operating drone to the user device, and wherein the electronic drone selection module selects the at least one drone in response to receiving at least one selected user-selectable criteria returned by the user device;

a feature of the at least one user-selectable criteria is selected from a list comprising camera type, pixel rate, video recording camera type, data streaming capability, sound recording capability, the maximum package delivery weight capability, night vision capability, weather-proofing availability, maximum speed, maximum altitude;

a feature of storing flight regulation data indicating at least one restricted travel zone; and

a feature of transmitting the flight regulation data to the selected at least one drone such that the at least one drone performs the service request while avoiding the at least one restricted travel zone.

According to still another embodiment, an electronic cost control system that controls at least one autonomous drone vehicle included in a drone service system to perform at least one service provided by the drone service system comprises an electronic drone selection module in signal communication with at least one electronic user device to receive at least one service request. The at least one service request indicates a request to perform a service provided by the drone service system at a user-selected maximum monetary cost. The drone selection module includes an electronic microprocessor having electronic memory that stores computer readable instructions that when executed by the microprocessor selects at least one autonomous drone vehicle from among a plurality of autonomous drone vehicles included in the drone service system based on the maximum monetary cost and commands the selected at least one autonomous drone to perform the service request.

In addition to one or more of the features described above or below, or as an alternative, further embodiments include:

a feature where an electronic fee control module in signal communication with the electronic drone selection module, the fee control module including an electronic microprocessor having electronic memory that stores computer readable instructions that when executed by the microprocessor continuously calculates a current monetary cost while the selected at least one autonomous drone performs the service request;

a feature where the electronic fee control module compares the current monetary cost and maximum monetary cost, and commands the electronic drone selection module to modify the service request when the current monetary cost exceeds the maximum monetary cost; and

a feature where the electronic fee control module determines a threshold value that is less than the maximum monetary cost, and transmits an alert to the GUI requesting modification of the requested service when the current monetary cost exceeds the threshold value.

Additional features are realized through the techniques of the present invention. Other embodiments are described in detail herein and are considered a part of the claimed invention. For a better understanding of the invention with the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing features are apparent from the following detailed description taken in conjunction with the accompanying drawings in which:

FIG. 1 illustrates a drone as a service (DaaS) system according to an exemplary embodiment;

FIG. 2A illustrates a graphic user interface (GUI) that is controlled by a user requesting a service provided by the DaaS system according to a non-limiting embodiment;

FIG. 2B illustrates a graphic user interface (GUI) that is controlled by a user requesting a service provided by the DaaS system according to another non-limiting embodiment;

FIG. 3 illustrates the GUI showing an image taken by a drone in response to a service request provided by the user according to a non-limiting embodiment;

FIG. 4 is a block diagram illustrating various electronic control modules that establish an electronic control system of the DaaS system according to a non-limiting embodiment;

FIG. 5 is a look-up table used to match a requested service provided by the DasS system with features included on one or more drone vehicle, and select at least one drone vehicle to perform the requested service; and

FIG. 6 is a flow diagram illustrating a method of performing a service provided by a DaaS system according to a non-limiting embodiment.

### DETAILED DESCRIPTION

Various embodiments of the invention provide drones as a service (DaaS) so that users with a certain set of needs or financial budget can automatically make use of one or more drones to achieve a task and while avoiding various burdens of ownership including, but not limited to, operating costs, repair costs, operational restriction and regulation awareness, and damage liability, and injury liability. According to a non-limiting embodiment, the DaaS includes an electronic database that stores zoning and flying restrictions, which allows for offloading liability of a user for improper flight operation to the DaaS. The DaaS also reduces a user's burden of determining what types of drones are capable of achieving particular tasks. For example, the DaaS may determine the operation status and location of one or more drones with respect to a location of a user with certain needs and a budget. Based on the user's needs and budget, the DaaS can automatically select or leverage one or more drones operating in the user's vicinity to complete the service(s) requested by the user while complying with an aviation authority's regulations and avoiding areas that are sensitive for privacy, safety, and other city/state restrictions. Technical effects and benefits of the various embodiments include, among other features, providing a drone as a service that allows one or more users to spontaneously request one or more services. The requested service is received, and one or more drones are automatically selected on the drone service side based on the user's service request. Once the service is completed, the results are automatically and conveniently delivered to the user. In this manner, a user can spontaneously request one or more services, which are then conveniently provided to a user without concerns regarding flight liability, drone operation, and/or monetary costs necessary to operate and maintain the drone.

According to at least one embodiment, the DaaS presents users with different features offered by the various drones available to the users, and different cost estimates based on the services requested and the features selected. The cost estimates may differ based on the various features provided by one or more drones such as, for example, distance of wireless transmission, security features, abilities to cooperate, differential access to one or more cloud hosts, use of different kinds of audio/visual components, different flight speeds, weather-proofing, package handling weight, etc. Accordingly, users can be provided with a service that spontaneously provides requested information or tasks by using one or more drones operating in the vicinity of the requested service or task.

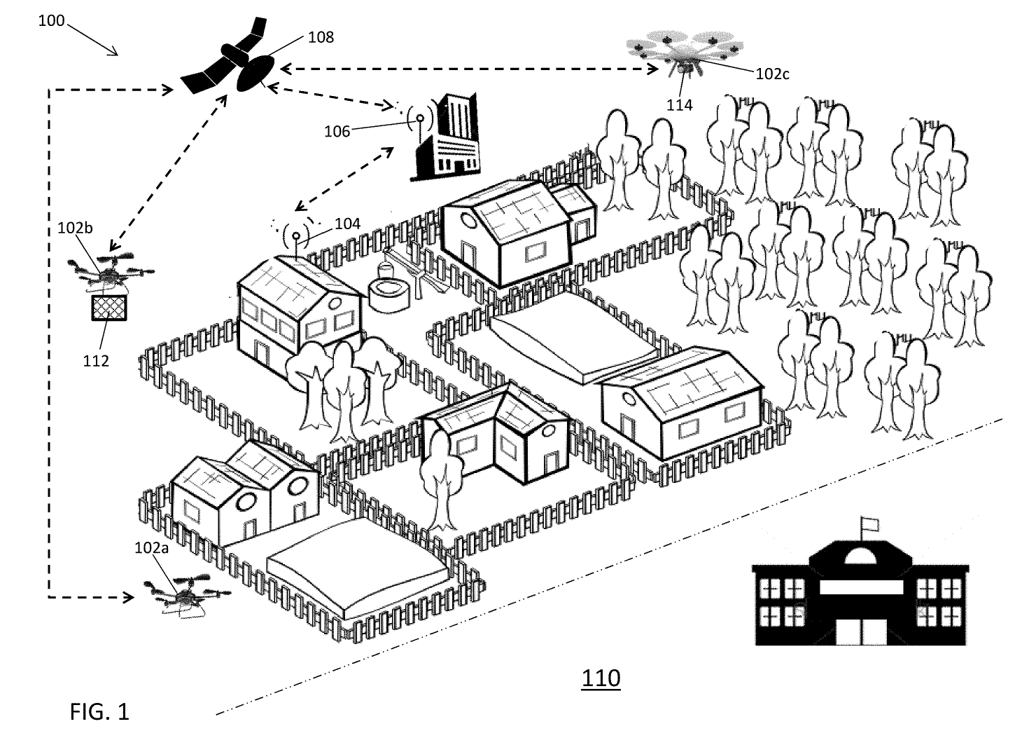

With reference now to FIG. 1, a DaaS system 100 is illustrated according to a non-limiting embodiment of the invention. The DaaS system 100 includes one or more drones 102a-102c configured to perform one or more services or tasks in response to a request provided by a user of the DaaS system 100. Although the drones 102a-102c are described in terms of autonomous aerial vehicles, it should be appreciated that the service can be performed by other types of drones including, but not limited to, autonomous sea-based drones and autonomous land-based drones. The service request may originate from a user node 104, which includes an electronic terminal device (not shown in FIG. 1) such as a computer work station, a computer laptop device, a wireless smartphone, or any other electronic device including an electronic microprocessor having electronic memory that stores computer readable instructions that when executed by the microprocessor performs signal communication with the DaaS system 100. According to a non-limiting embodiment, the user node 104 electrically communicates with a service node 106 located remotely from the user node 104.

The service node 106 is responsible for receiving the service request from a user and controlling one or more drones 102a-102c. The service node 106 includes any electronic service provider device including an electronic microprocessor having electronic memory that stores computer readable instructions that when executed by the microprocessor performs signal communication with the drones 102a-102c to facilitate the requested service. According to a non-limiting embodiment, the service node 106 may determine the real-time location of one or more drones 102a-102c via real-time global positioning satellite (GPS) data provided by a satellite 108, for example. Based on the real-time locations of the drones 102a-102c, the service node 106 can determine the features that are currently available to a user and may select the appropriate drone or drones 102a-102c to successfully complete the service requested by the user. For example, a first drone 102a may be located near regulated travel zones or regulated air space that includes, for example, federal, state, and/or city designated restricted travel zones (e.g., restricted air space) 110. Consequently, the first drone 102a may be aware of the restricted travel zones 110 and therefore must take a longer route to a location where the requested service is to take place. However, a second drone 102c, for example, may be located closer to a location at which the service requested is to take place. Accordingly, the service node 106 may select the second drone 102c to perform the services requested by the user such that the cost of the service remains within the user's budget.

The drones 102a-102c include an electronic flight controller (EFC) comprising an electronic microprocessor having electronic memory that stores computer readable instructions that when executed by the microprocessor controls the operation and flight of the drones 102a-102c. The drone's flight can be controlled either autonomously by the EFC or by the remote control of a pilot on the ground or in another vehicle. The drones 102a-102c can be commanded to autonomously perform a variety of services or tasks in real-time, including, but not limited to, thermal or video camera imaging, to parcels delivery, farming, surveying of crops, acrobatic aerial footage in filmmaking, search and rescue operations, construction industry, structure inspection (e.g., inspecting power lines, dams, pipelines), wildlife observation, delivering medical supplies, delivery to inaccessible regions, observations of illegal hunting by park rangers, livestock monitoring, wildfire mapping, pipeline security, home security, road patrol, and anti-piracy, search and rescue, dropping life preservers to plural swimmers, damage assessment, all-weather imaging through the clouds, rain, or fog, and in a daytime or night times conditions, illegal border crossing, or surveying roadways or trails for emergency vehicles . For example, drone 102b can perform delivery of a package 112, while drone 102c can perform image-capturing tasks using one or more on-board cameras 114. The drones 102a-102c can also use on-board sensors to perform remote sensing tasks including, but not limited to, multiple electromagnetic spectrum analysis, radiological analysis, biological analysis, chemical analysis, optical analysis, infrared analysis, thermal imaging analysis, synthetic aperture radar analysis, and solar ultra-violet (UV) ray analysis.

The drones 102a-102c via the EFC can also autonomously perform various flight operations to facilitate the service/tasks electrically transmitted by the service node 106. The autonomous flight operations include, but are not limited to, path planning to determine an optimal path for a vehicle to follow while meeting certain objectives and flight constraints, such as obstacles or fuel requirements, obstacle recognition allowing drones to autonomously avoid obstacles such as buildings, trees, etc. during flight, trajectory generation (i.e., motion planning) to determine optimal control maneuvers in order to follow a path necessary to complete the requested service or task, task regulation to determine specific control strategies required to constrain a vehicle within some tolerance or permissible airspace, task allocation and scheduling to determine the optimal distribution of each service request/task among a plurality of service requests/tasks within time and equipment constraints, and cooperative tactics to formulate an optimal sequence and spatial distribution of activities between agents to maximize the chance of success in any given mission scenario.

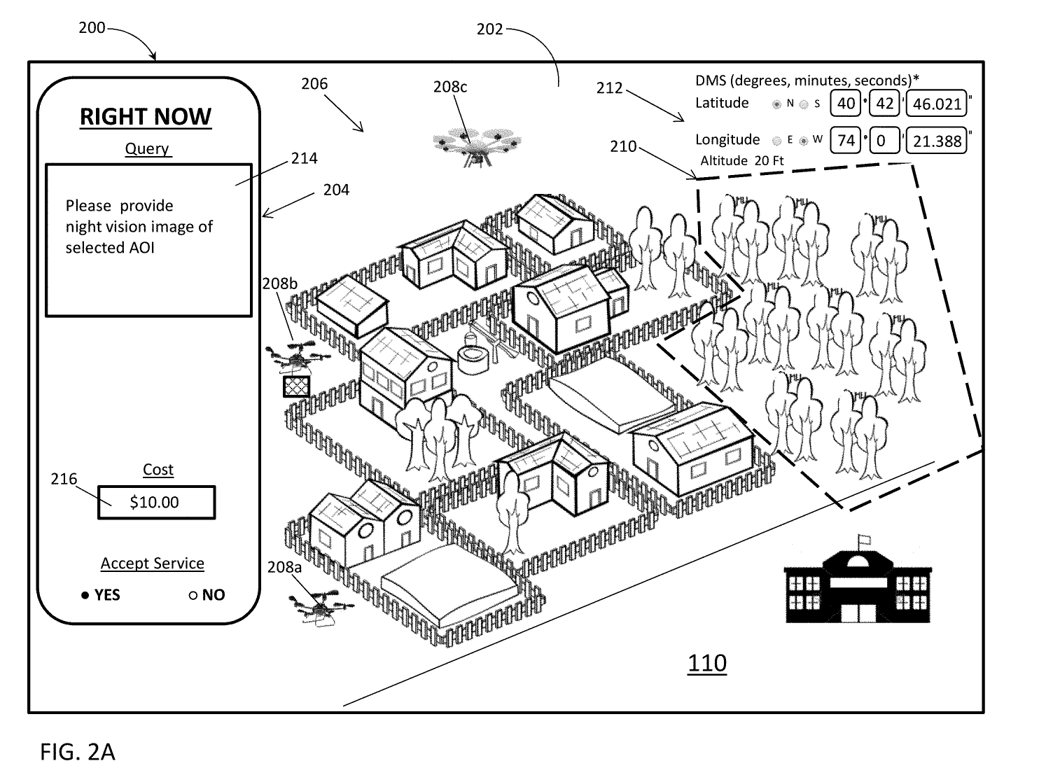

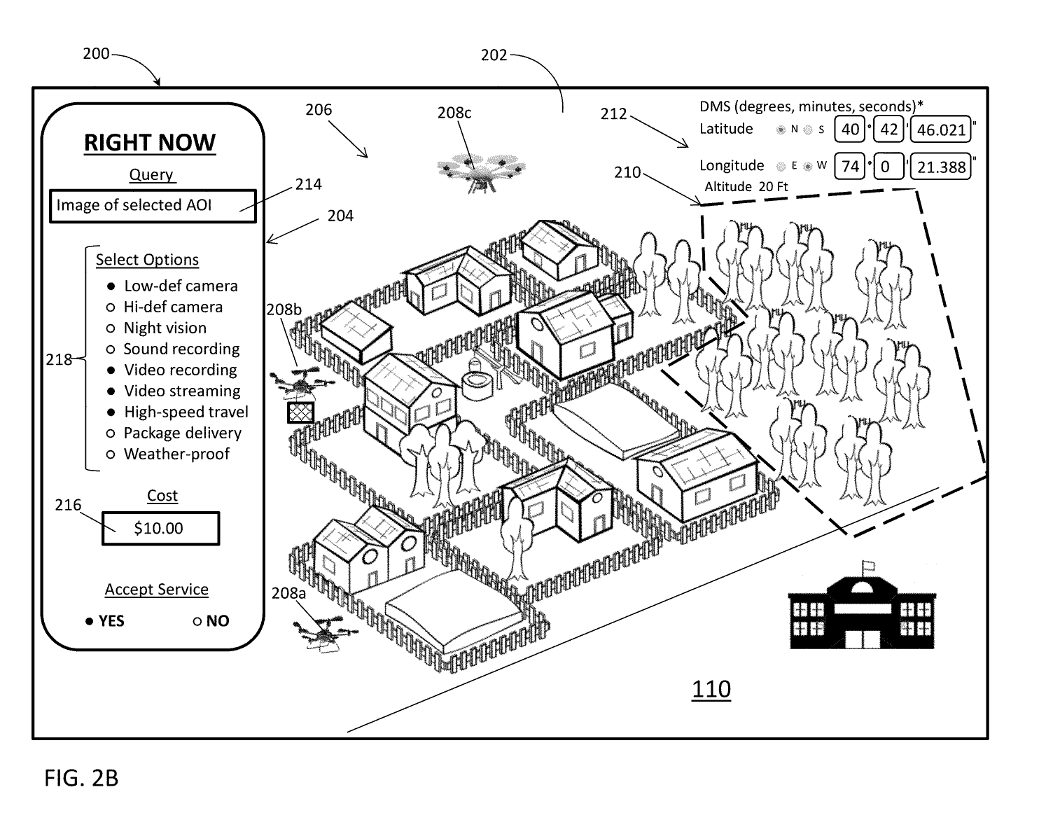

Turning now to FIG. 2, a graphical user interface (GUI) 200 corresponding to the DaaS system 100 is illustrated according to a non-limiting embodiment. The GUI 200 may include a display 202 configured to display various features and data corresponding to the DaaS system 100. According to a non-limiting embodiment, for example, the display 202 can present a GUI designer with an application programming interface (API) to create a web map 206 of a location designated by the user. The API can be manipulated by a programmer to provide the user with a web interface 204 as a means to input and select various desired options and services offered by the DaaS system 100, as discussed in greater detail below. According to a non-limiting embodiment, the API specifies a set of functions or routines that accomplish a specific task or are allowed to interact with specific software components. The API includes, for example, a source code interface that a microcontroller, computer system, or program library provides in order to support requests for services from the GUI 200. The API can also be specified in terms of a programming language that can be interpretative or compiled when an application is built, rather than an explicit low level description of how data is laid out in memory.

The GUI 200 may thereby overlay the web map 206 with a graphical icon that represents real-time locations of one or more drones 102a-102c with respect to the location designated by the user. According to a non-limiting embodiment, the user may also designate an area of interest (AOI) 210 at which the requested service is to be performed. The GPS coordinates of the AOI 210 can be entered into an AOI field 212 presented on the display 202 and/or can be automatically entered into the AOI field 212 in response to outlining the AOI 210 on the display 202 using an input device such as, for example, a mouse, a stylus, or contact with a touch screen of the GUI 200. According to another embodiment, a live-video feed may be transmitted from one more drones 102a-102c to the user node 104 and displayed on the GUI 200. The live-video feed may show a current location of a respective drone 102a-102c. Accordingly, a user viewing the live-feed may notice a desired AOI 210, and may request a service to be performed at the location of the desired AOI 210 viewed on the video-feed. In response to the service request, the service node 106 automatically determines the GPS location of the AOI 210 and commands one or more drones 210 to perform the service request.

According to a non-limiting embodiment the API automatically determines which various services and features that the DaaS system 100 can utilize to facilitate a service in real-time, “i.e., right now” in response to a requested service into the GUI 200.

According to another non-limiting embodiment, the API automatically presents the programmer with various services and features that the DaaS system 100 can offer in real-time, “right now”. For example, the API may support a query field 214 in which a user can input a service query or a request for service offered by the DaaS system 100. Based on the query input to the query field 214, the API, which are then constructed into user-selectable options 218 presented on the web interface 204 as illustrated in FIG. 2b. According to an embodiment, the API may also support a cost field 216 that indicates the cost or estimated cost of the queried service based on the features and options 218 selected by the user. In this manner, the user can determine whether the cost of the service is within a desired budget (e.g., maximum budget) before selecting to accept the service. Although not shown, it should be appreciated that other fields may be included in the API including, but not limited to, an estimated time of completion (ETC) field. In response to accepting the service, the information received through the API is communicated to the service node 106, which in turn selects the appropriate drone to facilitate the user's service request and commands the selected drone to perform the service accordingly.

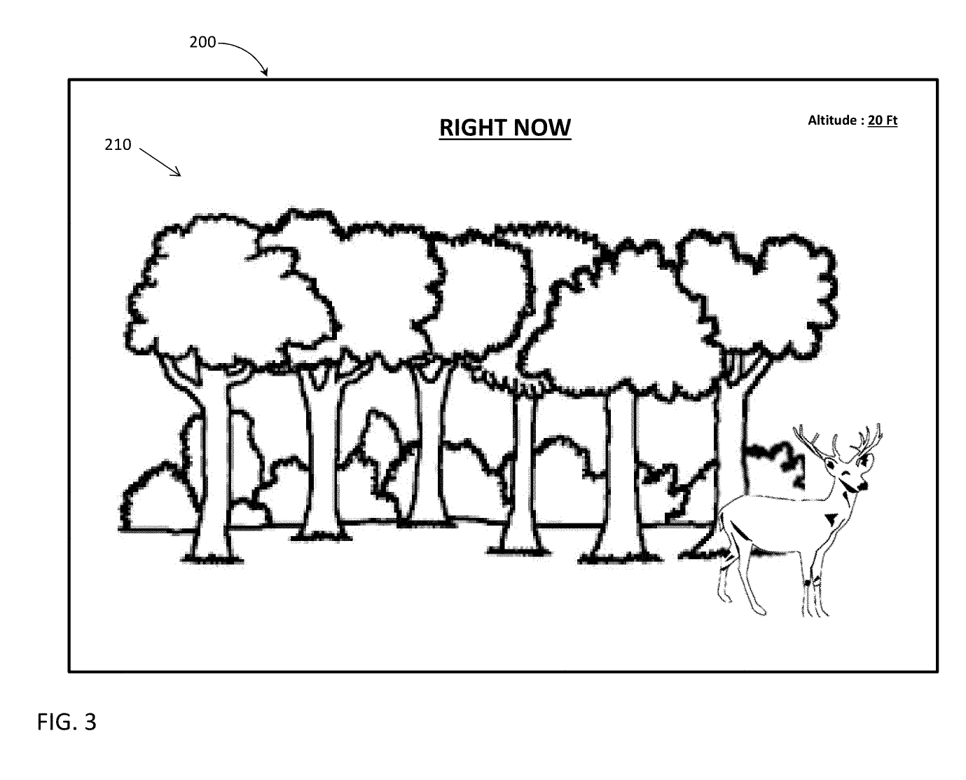

In response to completing the service requested by the user, the drone can transmit an acknowledgement signal to the service node 106 indicating that the requested services are completed. In addition to the acknowledgement signal, the drone also transmits any information or data collected according to the requested service. For example, if a user requests an image of the indicated AOI 210, the one or more drones 102a-102c that perform the requested service transmits one or more images to the service node 106. The service node 106 may then transmit the requested images to the user node 104 where the GUI 200 is configured to display the one or more images collected by the drones 102a-102c in the display 202. For example, a GUI 200 is shown displaying an image of the AOI 210 taken at an altitude of approximately 20 feet. Accordingly, the user is provided with an image of the AOI 210 which represents approximately the current state of the AOI 210, i.e., “right now” as illustrated in FIG. 3. Although an example of an image service is illustrated, it should be appreciated that various other services can be provided by the DaaS system 100. Other possible services provided by the DaaS system 100 may include, but are not limited to, package delivery, food service delivery, traffic congestion assessment, and weather condition assessment.

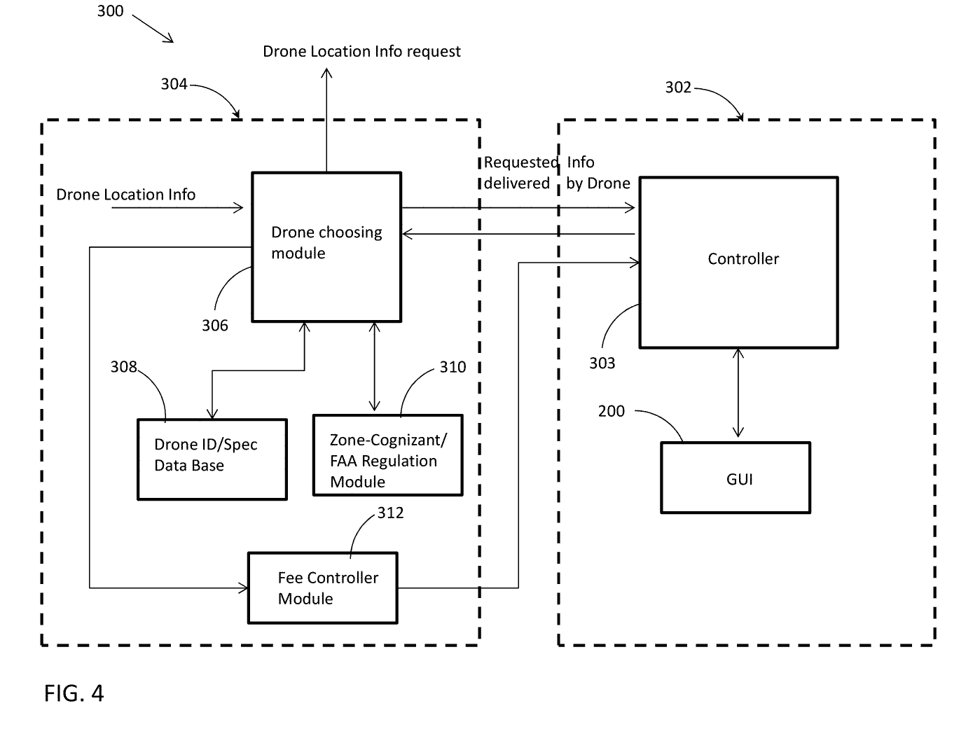

Turning now to FIG. 4, a block diagram of an electronic DaaS control system 300 implemented in a DaaS system 100 is illustrated according to a non-limiting embodiment. The DaaS control system 300 includes an electronic user device 302 and an electronic service provider system 304 located remotely from the user device 302. The electronic user device 302 includes any device comprising an electronic microprocessor having electronic memory that stores computer readable instructions that when executed by the microprocessor performs electrical signal communication with the service provider system 304 including, but not limited to, a computer workstation, an electronic tablet computer, and electronic smartphone.

The user device 302 includes an electronic microcontroller 303 and a GUI 200. It should be appreciated that the microcontroller 303 includes a microprocessor having electronic memory that stores computer readable instructions that when executed by the microprocessor performs various tasks and processes as understood by one of ordinary skill in the art. For example, the microcontroller 303 can access an application stored in memory that, when executed, renders and operates the GUI 200 on the user device 302. The microcontroller 303 is also configured to transmit input data received from a user via the GUI 200 to the service provider 304 according to well-known wireless transmission techniques understood by one of ordinary skill in the art. The microcontroller 303 is further configured to receive the requested information delivered by one or more drones performing the requested service, and construct the received data into a deliverable presented to the user via the GUI 200. The deliverable may include, for example, a map or image that is created as result of the user's service request.

The GUI 200 includes a display configured to display various input fields by the programmer using an API. The fields include, but are not limited to, a search inquiry field, various options and features related to an available service provided in response to the requested search query, and a total cost or estimated cost associated with completing the requested service. The GUI 200 may also display other information related to the DaaS system 100 including, but not limited to, a web map including an area of interest (AOI) 210, one or more icons 208a-208c indicating a real-time position of one or more drones capable of providing a requested service, final product corresponding to the completion of the service such as, for example, images of the AOI 210 or real-time data statistics such as weather conditions, traffic congestion, etc.

The electronic service provider system 304 includes an electronic drone selection module 306, an electronic drone identification (ID) database unit 308, and an electronic cognizant zone/regulation module 310. Each of the drone selection module 306, electronic drone ID database unit 308, and electronic cognizant zone/regulation module 310 include an electronic microprocessor having electronic memory that stores computer readable instructions that when executed by the microprocessor performs one or more processes described in detail below.

The drone selection module 306 is in electronic signal communication with the user device 302, and in particular via components implemented using API, to receive requested service data input by a user via the GUI 200. According to a non-limiting embodiment, the drone selection module 306 receives a service request (e.g., a search query) and one or more options or features related to the search request from a user. The drone selection module 306 then determines one or more drones available to facilitate and complete the user's service request.

The identification of available drones may be achieved using drone ID data (e.g., serial number) transmitted by the drones to the drone selection module 306. The drone ID data can be used to identify a particular drone currently in operation. More specifically, the drone ID database unit 308 is configured to store information corresponding to one or more drones registered in the DaaS system 100. For example, the drone ID database unit 308 stores a look-up table (LUT) cross-referencing at least one registered autonomous drone vehicle included in the drone service system with a respective drone ID. In this manner, the drone selection module 306 may compare the drone ID information received from a respective drone with the ID information stored in the drone ID database unit 308. Based on the comparison, the drone selection module 306 can determine which drones are currently operating among one or more drones registered in the system, and can determine the various characteristics corresponding to currently operating drones that are available to facilitate a user's service request. The various characteristics include, but are not limited to, image camera type (i.e., standard definition or high-definition), pixel rate, video recording camera type, data streaming capability, sound recording capability, the maximum package delivery weight capability, night vision capability, weather-proofing availability, maximum speed, maximum altitude, etc.

The characteristic information can also be stored in the drone ID database unit 308 and cross-referenced with the drone ID data transmitted by a respective drone so that the drone selection module can determine the characteristic information of each available drone. Each drone ID stored in the ID database unit 308 may also be cross-referenced with a monetary cost that is based on the types of drone characteristics associated with a respective drone. In this manner, different costs can be presented to a user based on the type of drone used to complete the service request. The user, therefore, can ultimately select which drone should be used to complete the service request within a user's desired monetary budget. According to another embodiment, the drone selection module 306 is also capable of determining the user's desired monetary budget and automatically selecting one or more drones to perform requested the service without requiring the user to select drones.

The drones also transmit GPS data to the drone selection module to indicate a current location of a respective drone. The GPS drone location information can be periodically sent to the drone selection module 306 and/or can be sent to the drone selection module 306 in response to a drone location request signal output by the drone selection module 306. In addition to the GPS information, a respective drone may provide various other types of flight data including, but not limited to, current energy availability such as, e.g., remaining battery life or fuel availability, current flight speed, and maintenance issues. Based on the location of the operating drones, the features/options corresponding to each operating drone, and/or the flight data, or each operating drone, the drone selection module 306 selects one or more drones to facilitate and complete the service request/tasks submitted by the user. For example, if a user submits a service request to capture an image of an AOI 210, the drone selection module 306 selects one or more drones including cameras capable of capturing an image, and may further select the appropriate drone closest to the location of the AOI 210 to complete the service request.

According to another embodiment, the drone selection module 306 may dynamically commission and decommission drones in/out of service. For instance, a drone may be activated in service but, while performing the service, may encounter low energy levels, i.e., low battery or maintenance issues. The drone selection module 306 may therefore decommission a particular drone encountering an emergency issue, and request commission of another drone located in the vicinity to complete the service request. According to another scenario, a drone in route to perform a service request corresponding to a first user may be leveraged to perform a second service request corresponding to a different user. For example, a drone en route to deliver a package according to a first service request submitted by a first user may be commanded to perform a slight detour en route and capture an image of an AOI 210 according to a second service request submitted by a second user. Accordingly, the drone selection module 306 may select a common drone to perform multiple services according to different requests submitted by different users.

The drone selection module 306 is also in electrical communication with the zone/regulation module 310. The zone/regulation module 310 is continuously updated with flight regulation information related to travel restricted zones, flight restricted air space and/or aviation authority, state, and/or city regulations. With respect to zone regulations for example, the zone/regulation module 310 may continuously be updated with GPS coordinates indicating restricted air space that must be adhered to by drones during in-flight operations. The zone information may be dynamically transmitted from the drone selection module 306 to one or more selected drones such that the drones may automatically travel along routes to perform the requested service without violating restricted airspace. Various other types flight regulation information is also provided to the drones, such as minimum and maximum altitude, such that the drones comply with aviation authority (e.g., FAA)/state/city regulations.

The electronic DaaS control system 300 further includes an electronic fee control module 312. The electronic fee control module 312 includes an electronic microprocessor having electronic memory that stores computer readable instructions that when executed by the microprocessor performs monetary cost computations and/or budget compliant analysis that allows the drone selection module 306 to modify service request in real-time. For example, the fee control module 312 is configured to calculate a monetary cost to use the DaaS system 100 based on the number of drones requested by a user, the features/capabilities on-board each requested drone, and the duration of use corresponding to each requested drone.

According to a non-limiting embodiment, for example, the fee control module 312 receives the service request and various features selected by the user from the electronic drone selection module 306. Based on the service request, the selected fees, and the drone selected by the drone selection module 306, the fee control module 312 calculates an estimated cost and/or total cost of the service provided by the DaaS system 100. The cost may include a basic monetary cost for utilizing the DaaS system 100, in addition to the type of drone(s) used to perform the service request, one or more additional fees associated with the drone features selected by the user, the total time or usage of the DaaS system 100, the distance travelled by one or more drones necessary to complete the service, weather conditions in which the service was performed in. Once the service is completed, the drone selection module 306 generates a completion signal to the fee control module 312 indicating the service is completed, and the fee control module 312 generates a cost signal to the user device 302 indicating a total cost of the service. The user device 302 may display the total cost via the GUI 200 in addition to the final product/information requested in response to the user's initial service request query.

According to another non-limiting embodiment, a user submits a monetary budget for performing one or more requested services. The budget value is relayed to the fee control module 312 which identifies one or more available drones to the drone selection module 304 that will satisfy the user's budget. Further, the fee control module 312 is configured to monitor the on-going costs that may accrue while performing user's service request and compares the on-going cost to the user's budget. If the on-going cost exceeds a threshold value, the fee controller alerts the drone selection module 304, which can then remove one or more drone's from service, cancel the service, or transmit a signal to the user device 302 alerting the user that the on-going cost is approaching the user's budget. The user can then submit a request to continue the service, modify the service, cancel the service, etc.

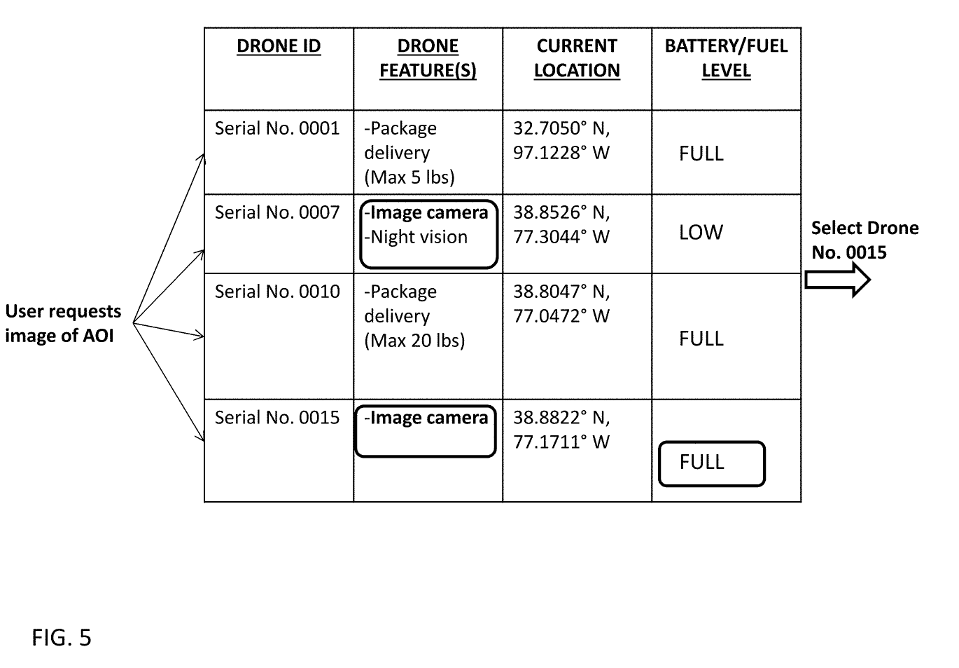

Referring to FIG. 5, a look-up table (LUT) used to match a requested service provided by the DasS system 100 with features included on one or more drone vehicle is illustrated according to a non-limiting embodiment. In this manner, the LUT is used to select at least one drone vehicle to perform service request. For instance, the drone selection module 304 automatically compares at least one received user-selectable criteria with at least one the drone features installed on one or more drone vehicles among the plurality of drone vehicles available to perform the service request. Based on a match between the service request and one or more drones including drone features capable of facilitating the service request, the drone selection module 304 automatically selects the at least one drove vehicle.

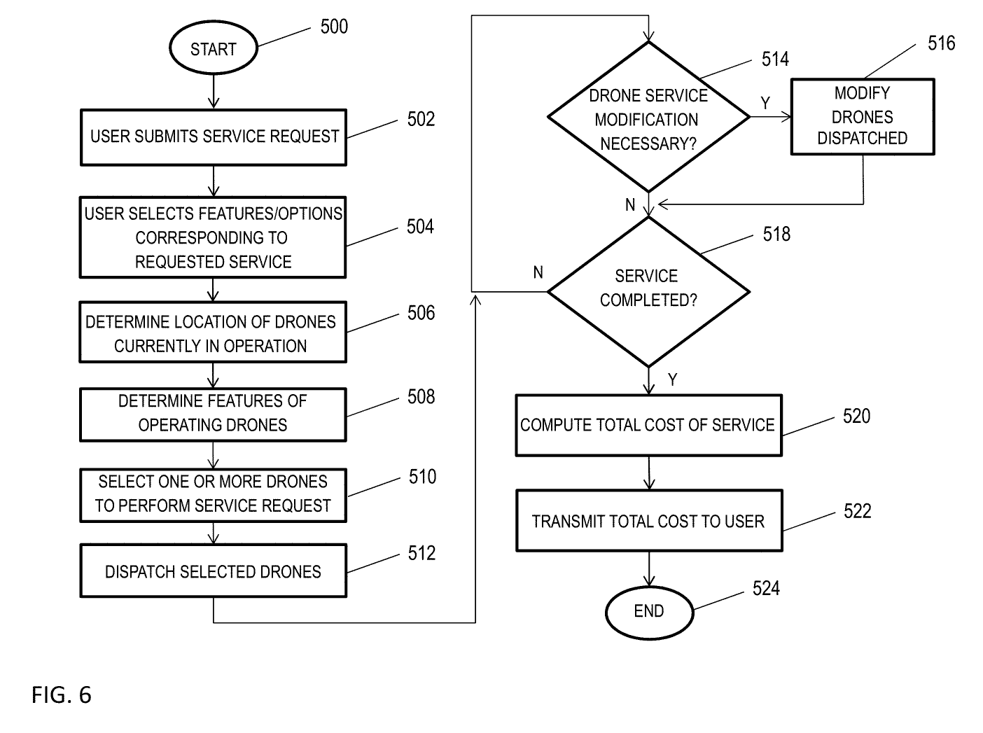

Turning now to FIG. 6, a flow diagram illustrating a method of performing a service provided by the DaaS system is illustrated according to a non-limiting embodiment. The method starts at operation 500 and at operation 502 a user submits a service request via a GUI, for example. The service request may include, but is not limited to, a request for an image of an AOI, weather conditions, traffic conditions, etc. At operation 504, the user selects one or more features/options corresponding to the requested service. For example, a user requesting an image of an AOI may also select the resolution of the image, the number of images, and characteristics of the image such as black and white, etc. At operation 506, the location of one or more drones currently in operation is determined. The location of the drones can be determined using GPS information transmitted from a respective drone. At operation 508, one or more features corresponding to a drone currently available to perform the service is determined. For instance, a drone currently in service may also communicate drone ID information indicating the various features such as whether the drone includes an image camera, video recording camera, the maximum package delivery weight, etc.

At operation 510, one or more drones are selected to perform the service requested by the user. For example, in response to receiving a service request to photograph an AOI, all drones including an image photographing camera are filtered from the group of available drones, and one or more drones including a camera is selected. The selected drones are then dispatched at operation 512 to perform or facilitate the service requested by the user. At operation 514, a decision to modify the current selection of drones is performed. The modification may be in response to various changing events including, but not limited to, energy levels of the drone, weather conditions, the budget of the user, or cancellation of the service. If the service requires modification, the selected drones are modified, i.e., a drone is removed or added to the service at operation 516 and the method moves to 518 to determine whether the service is complete. Otherwise, if a modification is unnecessary, the method moves to operation 518 to determine whether the service is complete. If the service is not complete, the method returns to operation 514 to continue monitoring whether service modification is necessary. If the service is complete however, the method moves to operation 520 and a total cost of the service is computed. At operation 522, the cost of the service is transmitted to the user and the method ends at 524.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

As used herein, the term module refers to a hardware module including an Application Specific Integrated Circuit (ASIC), an electronic circuit, a processor (shared, dedicated, or group) and memory that execute one or more software or firmware programs, a combinational logic circuit, and/or other suitable components that provide the described functionality.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the inventive teachings and the practical application, and to enable others of ordinary skill in the art to understand the invention for various embodiments with various modifications as are suited to the particular use contemplated.

The flow diagrams depicted herein are just one example. There may be many variations to this diagram or the operations described therein without departing from the spirit of the invention. For instance, the operations may be performed in a differing order or operations may be added, deleted or modified. All of these variations are considered a part of the claimed invention.

While various embodiments have been described, it will be understood that those skilled in the art, both now and in the future, may make various modifications which fall within the scope of the claims which follow. These claims should be construed to maintain the proper protection for the invention first described.

What is claimed is:

1. An electronic cost control system that controls at least one autonomous drone vehicle included in a drone service system to perform at least one service provided by the drone service system, the cost control system comprising:
an electronic drone selection module in signal communication with at least one electronic user device to receive at least one service request to perform a service provided by the drone service system at a user-selected maximum monetary cost, the drone selection module including an electronic microprocessor having electronic memory that stores computer readable instructions that when executed by the microprocessor selects at least one autonomous drone vehicle from among a plurality of autonomous drone vehicles included in the drone service system based on the maximum monetary cost and commands the selected at least one autonomous drone to perform the service request.

2. The electronic cost control system of claim 1, further comprising an electronic fee control module in signal communication with the electronic drone selection module, the fee control module including an electronic microprocessor having electronic memory that stores computer readable instructions that when executed by the microprocessor continuously calculates a current monetary cost.

3. The electronic cost control system 2, wherein the electronic fee control module calculates a current monetary cost while the selected at least one autonomous drone performs the service request.

4. The electronic cost control system of claim 3, wherein the commands the electronic drone selection module to modify the service request current monetary cost and the maximum monetary cost.

5. The electronic cost control system of claim 4, wherein the electronic fee control module compares the current monetary cost and maximum monetary cost, and commands the electronic drone selection module to modify the service request when the current monetary cost exceeds the maximum monetary cost.

6. The electronic cost control system of claim 3, wherein the electronic fee control module outputs a modification alert to request modification of the requested service based on a threshold value.

7. The electronic cost control system of claim 3, wherein the electronic fee control module sets the threshold value less than the maximum monetary cost, and transmits the modification alert to the GUI requesting modification of the requested service when the current monetary cost exceeds the threshold value.

8. A method of controlling an electronic cost control system that controls at least one autonomous drone vehicle included in a drone service system to perform at least one service provided by the drone service system, the method comprising:
receiving, via an electronic drone selection module in signal communication with at least one electronic user device, at least one service request to perform a service provided by the drone service system at a user-selected maximum monetary cost;
selecting, via an electronic microprocessor, at least one autonomous drone vehicle from among a plurality of autonomous drone vehicles included in the drone service system based on the maximum monetary cost; and
commanding the selected at least one autonomous drone to perform the service request.

9. The method of claim 8, further comprising continuously calculating a current monetary cost while the selected at least one autonomous drone performs the service request.

10. The method of claim 9, further comprising:
comparing the current monetary cost and maximum monetary cost; and
commanding the electronic drone selection module to modify the service request based on the comparison.

11. The method of claim 10, further comprising modifying the service when the current monetary cost exceeds the maximum monetary cost.

12. The method of claim 11, further comprising outputting a modification alert to request modification of the requested service based on a threshold value.

13. The method of claim 12, wherein outputting the modification alert further comprises:
determining a threshold value that is less than the maximum monetary cost; and
transmitting an alert to the GUI requesting modification of the requested service when the current monetary cost exceeds the threshold value.

14. A method of controlling an electronic cost control system that controls at least one autonomous drone vehicle included in a drone service system to perform at least one service provided by the drone service system, the method comprising:
receiving, via an electronic drone selection module in signal communication with at least one electronic user device, at least one service request to perform a service provided by the drone service system at a user-selected maximum monetary cost;
selecting, via an electronic microprocessor, at least one autonomous drone vehicle from among a plurality of autonomous drone vehicles included in the drone service system based on the maximum monetary cost;
commanding the selected at least one autonomous drone to perform the service; and
modifying the service based on at least one of monetary cost computation and a budget compliant analysis.

15. The method of claim 14, wherein modifying the service is performed in real-time.

16. The method of claim 15, wherein the at least one of monetary cost computation and the budget compliant analysis comprising continuously calculating a current monetary cost while the selected at least one autonomous drone performs the service request.

17. The method of claim 16, wherein the at least one of monetary cost computation and the budget compliant analysis further comprises:
comparing the current monetary cost and maximum monetary cost; and
commanding the electronic drone selection module to modify the service request based on the comparison.

18. The method of claim 17, further comprising modifying the service when the current monetary cost exceeds the maximum monetary cost.

19. The method of claim 18, further comprising outputting a modification alert to request modification of the requested service based on a threshold value.

20. The method of claim 19, wherein outputting the modification alert further comprises:
determining a threshold value that is less than the maximum monetary cost; and
transmitting an alert to the GUI requesting modification of the requested service when the current monetary cost exceeds the threshold value.
